(19) United States
(12) Patent Application Publication
(10) Pub. No.: US 2024/0386543 A1
(43) Pub. Date: Nov. 21, 2024

(54) FATIGUE CRACK PROPAGATION RATE TEST METHOD AND DEVICE BASED ON DEEP LEARNING

(71) Applicant: HUNAN UNIVERSITY, CHANGSHA (CN)

(72) Inventors: Xiangyun Long, CHANGSHA (CN); Chao Jiang, CHANGSHA (CN); Mengchen Yu, CHANGSHA (CN)

(21) Appl. No.: 18/786,513

(22) Filed: Jul. 28, 2024

Related U.S. Application Data
(63) Continuation of application No. PCT/CN2023/090176, filed on Apr. 24, 2023.

(30) Foreign Application Priority Data
Jul. 1, 2022 (CN) 202210774131.X

(51) Int. Cl. G06T 7/00

(52) U.S. Cl. CPC G06T 7/0004; G06T 2207/20081; G06T 2207/20084; G06T 2207/30108

(57) ABSTRACT

A fatigue crack propagation rate test device and method based on deep learning, comprises a dual scale Faster Region-based Convolutional Neural Network (Faster-RCNN) to accurately measure a crack length. The device can be used for tracking a crack propagation length of a non-standard test-piece having any geometric size. The method comprises: firstly, acquiring crack data sets of different scales by means of a camera; secondly, training the crack data sets by using the Faster-RCNN; then, constructing a global and local dual scale fast convolutional neural network, and predicting crack lengths under whole times of load cycle; and finally, fusing fracture mechanics to obtain a relationship between the fatigue crack propagation rate and a crack tip stress intensity factor.

### RELATED APPLICATION

This application is a continuaton of PCT international application No. PCT/CN2023/090176,which has an international filing date of Apr. 24, 2023, which claims priority to Chinese Patent Application No. 202210774131.X, filed on Jul. 1, 2022, entitled “Fatigue Crack Propagation Rate Test Method and Device Based on Deep Learning”. The content of the above identified applications are hereby incorporated in their entireties by reference for all purposes.

### FIELD OF THE INVENTION

The present invention relates to the technical field of fatigue strength of materials, and relates generally to a fatigue crack propagation rate test method and device based on deep learning.

### BACKGROUND

Fatigue crack propagation rate test is an important part of fatigue crack propagation life prediction, which is of great significance for structural fatigue life assessment and damage tolerance design.

The fatigue crack propagation rate test aims to determine the relationship between the crack propagation rate and the crack tip stress intensity factor. The crack propagation rate test method mainly includes three steps of performing cyclic loading on test-pieces with precracks; acquiring the relationship between crack length and times of cycle; and expressing the crack propagation rate as a function of stress intensity factor according to elastic fracture mechanics. The accurate measurement of the crack length is very important in the experiment process, which directly affects the accuracy of crack propagation rate measurement. Classical crack length measurement methods include visual measurement methods and non-visual measurement methods. For the visual measurement method, a low-power microscope relying on thread transmission is mainly used. In the experiment process, manually reading the surface crack length will be affected by an operator's degree of fatigue, sense of responsibility and experience and other factors, the change rule of crack length with times of cycle cannot be automatically measured, and it is difficult to meet the requirements of repeated and large scale test. Non-visual measurement method techniques are mostly automated, but all rely on a calibration curve associated with the test-pieces of particular geometric sizes. Therefore, most of these techniques are based on national standard test-pieces for crack propagation rate test. However, many key components in the existing equipment are difficult to be processed into standard test-pieces, such as a helicopter tail transmission shaft, which are processed and molded to be thin bending tube axis test-pieces, from which the test-pieces meeting the national standards are taken. For similar non-standard experiments, the flexibility method and the potential method are difficult to adapt to the geometric changes of non-standard samples, while the visual measurement method is affected by the degree of fatigue, responsibility and experience of operators, and is difficult to meet the requirements of repeatability and large scale test. However, the commonly-used existing crack length measuring device crack propagation extensometer (COD gauge) is only applicable to the standard test-piece, and it is difficult to measure the crack length of the non-standard test-piece whose geometry does not meet the standard specification.

With the development of artificial intelligence technology, the deep learning method has been successfully applied in the fields of speech identification, computer vision and so on, because it can automatically extract features and be integrated into moving devices to achieve automation. Convolution neural network, as one of the important representatives of deep learning, is widely used in crack detection, but the research focuses on crack identification. A small amount of work has been done on the measurement of crack length based on the convolution neural network, but the effective measurement is mainly done on the macro scale building cracks with larger size. For the fatigue crack propagation test, the crack size is small, and the measurement accuracy of this method is still difficult to meet the requirements. Therefore, in order to solve the problem of fatigue crack propagation, it is necessary to develop a new generation of fatigue crack propagation rate test method and device based on artificial intelligence technology, which is expected to realize the intelligent real-time monitoring of fatigue crack propagation rate and overcome the difficult problem that traditional methods and devices are difficult to adapt to non-standard test-piece fatigue crack propagation test.

### SUMMARY

The present invention provides a fatigue crack propagation rate test device based on deep learning, wherein the fatigue crack propagation rate test device includes an acquisition unit, a processing unit and a display unit;
the acquisition unit is configured to acquire a picture of a tested member;
the display unit is configured to show a crack detection result, display a position of the crack in the crack test-piece picture and output the detected crack length;
the processing unit is configured to load a dual scale crack test-piece data set, a dual scale identification module and a module for fitting a relationship between a fatigue crack propagation rate and a stress intensity factor;
the dual scale crack test-piece data set includes a global scale data set and a local scale data set, where the global scale data set stores a panoramic image in a test-piece crack propagation experiment, and the local scale data set stores an image only containing crack information in the test-piece crack propagation experiment;
the dual scale identification module includes a global scale identification module and a local scale identification module; the global scale identification module is trained by the global scale data set, and used for identifying the location and length of a long crack or a preliminary detection result of a short crack; the local scale identification module is trained by the local scale data set, and used for identifying the location and length of the short crack; and
the module for fitting a relationship between a fatigue crack propagation rate and a stress intensity factor is used for acquiring the stress intensity factor of any crack test-piece on the crack propagation path and constructing a function of the crack propagation rate and the stress intensity factor

Further, both the global scale model and the local scale model adopt a Faster-RCNN network including a basic CNN network, a RPN network and a Fast-RCNN network;
the basic CNN network performs feature map extraction on the data set and is respectively connected to the RPN network and the Fast-RCNN network;
in the process of training the RPN network, the RPN network is connected to the dual scale crack test-piece data set at the same time to acquire annotation information to generate a suggestion box;
the Fast-RCNN network includes a RoI pooling layer and a full-connection layer, which are respectively connected to a basic CNN network and a RPN network; based on a feature map of the basic CNN network and a suggestion box of the RPN network, the features surrounded by the suggestion box are referred to as generating a region of interests; the region is further input to the RoI pooling layer to extract a feature vector of a pre-set size; the feature vector is fed into the full-connection layer, objects in the image are classified by the full-connection layer, and the center coordinates, height and width of the crack bounding box are determined.

Further, the dual scale identification module calculates a crack length from a preset pixel-to-real size relationship based on a crack pixel size in the output image.

Still further, the function of the fatigue crack propagation rate and the stress intensity factor of the module for fitting a relationship between a fatigue crack propagation rate and a stress intensity factor may be expressed as follows:

$$da / dN = {C ( Δ K )}^{m}$$

where, C and m reprensent crack propagation constants respectively and ΔK reprensents a variation amplitude of the stress intensity factor.
under a constant amplitude load F, the relationship that the stress intensity factor changes with the crack propagation length a can be expressed as follows:

$$K = ( F / {BW}^{1 / 2} ) \times f ( a / W )$$

$$where :$$

$$f ( a / W ) = ( 2 + a / W ) \times \frac{{k}_{0} + {k}_{1} ( a / W ) + {{k}_{2} ( a / W )}^{2} + {{k}_{3} ( a / W )}^{3} + {{k}_{4} ( a / W )}^{4}}{{( 1 - a / W )}^{3 / 2}}$$

where F reprensents a loading force, B reprensents a thickness of the test-piece, W reprensents a gauge length of the test-piece, a reprensents crack length, f reprensents a shape factor related to the geometric size of the test-piece, k₀, k₁, k₂, k₃ and k₄ reprensent the coefficients to be determined.

A fatigue crack propagation rate test method based on deep learning is further provided, which includes the steps of:
step 1: acquiring photographs of test-pieces for training, and constructing a dual scale crack test-piece data set crack test-piece data set;
step 2: training the dual scale identification module through the dual scale crack test-piece data set
step 3: acquiring a picture of a test-piece to be tested in real time, and determining whether there is a crack and a crack length through a trained dual scale identification module; and
step 4: obtaining the relationship that the crack propagation rate changes with the crack length through the fatigue crack length at different times of load cycle.

Further, in step 3, the following steps are also included:
step 31: photographing by means of a camera in the crack propagation experiment to acquire a data set;
step 32: inputting the global picture in the data set into a global scale model to determine whether the tested member has a crack, and if it is a long crack global scale model, calculating the crack length; and
step 33: if it is a short crack, generating a local image of the crack and inputting same into the local scale model, and calculating the crack length.

Further, in step 32, if the crack length is greater than 6 mm, it is determined as a long crack, otherwise, it is determined as a short crack.

The advantageous effects achieved by the present invention are:
an objective of the present invention is to solve the problem that the traditional fatigue crack propagation rate test method is difficult to be adapted to the geometric changes of non-standard samples, and is difficult to meet the requirements of repeatability and large scale experiment, etc. and to propose a fatigue crack length measurement and propagation rate test method and device based on deep learning, which can conveniently and quickly realize the real-time measurement of crack length and the crack propagation rate test. This method overcomes the shortcomings of the traditional flexibility method and potential method which are difficult to adapt to the non-standard sample. The present invention can achieve crack length measurement and the propagation rate test of the non-standard test-piece having any geometric size, can achieve automatically measurement for the crack length in a fatigue crack propagation test process in real time, and test the crack propagation rate.

The method of the present invention overcomes the short crack prediction accuracy deficiency of the conventional single scale Faster R-CNN by developing a novel dual scale Faster R-CNN to automatically identify and accurately measure cracks at different times of cycle.

The dual scale detection method proposed in the present invention can automatically measure the crack length on any picture or video taken during the whole process of crack propagation, and can achieve high-precision measurement for both the short crack in the initial stage of crack propagation and the long crack in the middle and late stage of crack propagation, which makes up for the low accuracy of short crack detection in the traditional single scale network.

### BRIEF DESCRIPTION OF DRAWINGS

FIG. 1 is a schematic diagram showing a frame of a dual scale identification module in a fatigue crack propagation rate test device based on deep learning;

FIG. 2 is a schematic structural diagram showing a fatigue crack propagation rate test device based on deep learning;

FIG. 3 is a schematic diagram showing the size and model of a non-standard crack propagation test-piece for a tube axis in a fatigue crack propagation rate test method based on deep learning;

FIG. 4 is an example schematic diagram showing global scale and local scale data sets in the fatigue crack propagation rate test method based on deep learning;

FIG. 5 is a diagram showing training loss and verification loss of a global scale crack changed with times of training during training in the fatigue crack propagation rate test method based on deep learning;

FIG. 6 is a diagram showing training loss and verification loss of a local scale crack changed with times of training during training in a fatigue crack propagation rate test method based on deep learning;

FIG. 7 is a schematic diagram showing crack detection in a fatigue crack propagation rate test method based on deep learning;

FIG. 8 is a diagram showing a crack length changed with times of cycle in a fatigue crack propagation rate test method based on deep learning.

### DETAILED DESCRIPTION

The technical solutions of the present invention will be described in more detail below with reference to the accompanying drawings, and the present invention includes, but is not limited to, the following embodiments.

The present invention provides a fatigue crack propagation rate test device based on deep learning, which includes an acquisition unit, a processing unit and a display unit.

The acquisition unit is a high-definition camera or a single lens reflex, and the acquisition unit is set at the position facing the test-piece in a forward tension-torsion combined fatigue test system, and is used for acquiring a picture of the test-piece.

The processing unit is a local computer or a cloud computing server, and is used for loading a dual scale crack test-piece data set, a dual scale identification module and a module for fitting a relationship between a fatigue crack propagation rate and a stress intensity factor.

The dual scale crack test-piece data set is obtained by acquiring the image data of the whole process of the fatigue crack propagation test through a single lens reflex, which is used to train and test the global scale Faster R-CNN identification module and the local scale Faster R-CNN identification module in the process of fatigue cyclic loading experiment on the tension-torsion combined fatigue test system (MTS).

The dual scale crack test-piece data set includes a global scale data set and a local scale data set. The global scale data set is used for training and testing a global scale Faster R-CNN identification module; panoramic images are obtained by taking pictures in the test-piece crack propagation experiment with a common camera; 50% of the images is randomly selected from the data set as a training set, 33.3% of the images as a verification set, leaving 16.7% of the images as a test set. The local scale data set is obtained by locally clipping the images containing short cracks in the training set and the verification set of the global scale data set, and removing environmental information such as a clamp outside the cracks, and only containing crack information located in the middle of the image; 60% of the images is randomly selected from the data set as the training set, leaving 40% of the images as the verification set.

The dual scale identification module includes a global scale identification module and a local scale identification module for automatically identifying the cracks existing in the picture based on neural network technology, and identifying the location of the cracks.

The global scale identification module detects the global scale of a picture of cracks by means of a global scale long crack data set model, and detects the position of a long crack in the picture or the preliminary detection result of a short crack. When the crack size on the image is relatively long, the crack length can be accurately measured by the global scale identification module. However, when the crack length on the image is relatively short, since the local small crack information is easily ignored after the input picture is scaled, there is a large error in the result of measuring the short crack length using only the global scale identification module.

The local scale identification module detects the local scale of the picture of cracks by using the local scale short crack data set model, forms the accurate detection result of the short crack, and detects the location and length of the short crack in the picture.

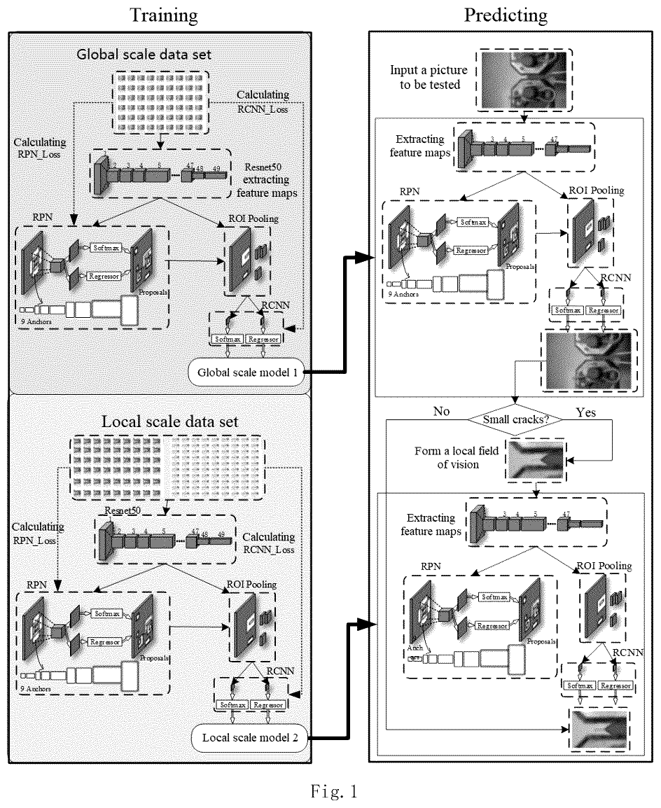

As shown in FIG. 1, the dual scale identification module includes a global scale model and a local scale model. Both the global scale model and the local scale model use Faster-RCNN network including basic CNN network, Region proposal network (RPN network) and Fast region-based convolutional network (Fast-RCNN network).

The basic CNN network performs feature map extraction on the data set, and the basic CNN network connects the RPN network and the Fast-RCNN network respectively. Since the basic CNN is shared by the RPN and the Fast R-CNN for feature extraction, the Faster RCNN can input pictures for fast processing.

In the training process of RPN network, the RPN network is connected with the dual scale crack test-piece data set to obtain annotation information, and in order to generate a suggestion box, a spatial window slides on the feature map, and multiple anchor boxs are generated in each window; these anchor boxs will be distinguished as objects and background by a target classification layer, and bounding boxs with dimensional information such as center coordinates (x and y) and box size (width and height) are provided by a regression layer; finally, RPN provides suggestion boxs and scores of possible locations for the cracks.

The Fast-RCNN network includes a RoI pooling layer and a full-connection layer (FCL), which are respectively connected to a basic CNN network and a RPN network; based on the feature map of the basic CNN network and the suggestion box of the RPN network, the features surrounded by the suggestion box are referred to as generating region of interests (RoIs); these Rols are further input to a RoI pooling layer, and a feature vector of a preset size is extracted from each RoI by applying a maximum pooling operation; these feature vectors are fed into the full-connection layer, objects in the image are classified by a Softmax classification layer, and the center coordinates, height and width of the crack bounding box are determined by the regression layer.

The dual scale identification module calculates a crack length from a preset relationship of pixel-to-real size based on a crack pixel size in the output image.

In the next step, the local view box of the short crack is input into the local scale model to continue the detection, and through the basic CNN network, the RPN, the RoI pooling layer and the full-connection layer, and finally the detection result of the crack length in the picture is output. Compared with the traditional single scale Faster R-CNN target detection network structure, this dual scale network structure automatically determines the length of the detection results of the global scale model by concatenating the global scale and local scale models, and continues to detect and measure the length through the local scale model if the network determines it is short crack.

The module for fitting a relationship between a fatigue crack propagation rate and a stress intensity factor is mainly used for obtaining the stress intensity factor of any crack test-piece on the crack propagation path and constructing a function of the crack propagation rate and the stress intensity factor;

The module for fitting a relationship between a fatigue crack propagation rate and a stress intensity factor obtains the fatigue crack length a under different times of load cycle through the above-mentioned dual scale Faster R-CNN, and can further obtain the relationship between the fatigue crack propagation rate and the crack length a, i.e., a curvilinear relationship of da/dN ˜a. In the existing fatigue crack propagation test methods, the crack propagation rate function is usually constructed for standard crack propagation test-pieces. A method of constructing both standard and non-standard crack propagation rate function is given. According to the Paris rate equation, the function of fatigue crack propagation rate and stress intensity factor can be expressed as follows:

$$da / dN = {C ( Δ K )}^{m} \qquad ( 1 )$$

where, C and m represent crack propagation constants respectively and ΔK represents a variation amplitude of the stress intensity factor. Under a constant amplitude load F, the relationship that the stress intensity factor changes with the crack propagation length a can be expressed as follows:

$$K = ( F / {BW}^{1 / 2} ) \times f ( a / W ) \qquad ( 2 )$$

$$where :$$

$$( 3 )$$

$$f ( a / W ) = ( 2 + a / W ) \times \frac{{k}_{0} + {k}_{1} ( a / W ) + {{k}_{2} ( a / W )}^{2} + {{k}_{3} ( a / W )}^{3} + {{k}_{4} ( a / W )}^{4}}{{( 1 - a / W )}^{3 / 2}}$$

where F represents a loading force, B represents a thickness of the test-piece, W represents a gauge length of the test-piece, a represents crack length, f represents a shape factor related to the geometric size of the test-piece, k₀, k₁, k₂, k₃ and k₄ represent the coefficients to be determined. For non-standard test-pieces, the undetermined coefficients shall be fitted in combination with three-dimensional fracture mechanics. The relationship between the stress intensity factor (K) and the crack propagation length (a) is calculated by three-dimensional crack propagation simulation, and, undetermined coefficients k₀, k₁, k₂, k₃ and k₄ can be obtained by fitting combined with equations (2) and (3). Equations (2) and (3) can be input to equation (1), combined with da/dN ˜a curvilinear relationship, the fatigue crack propagation rate constant C and m can be obtained by fitting.

The display unit is a display or a touch capacitance screen, and the display unit is configured to display a crack detection result, display the position of a crack in a crack test-piece picture and output the detected crack length.

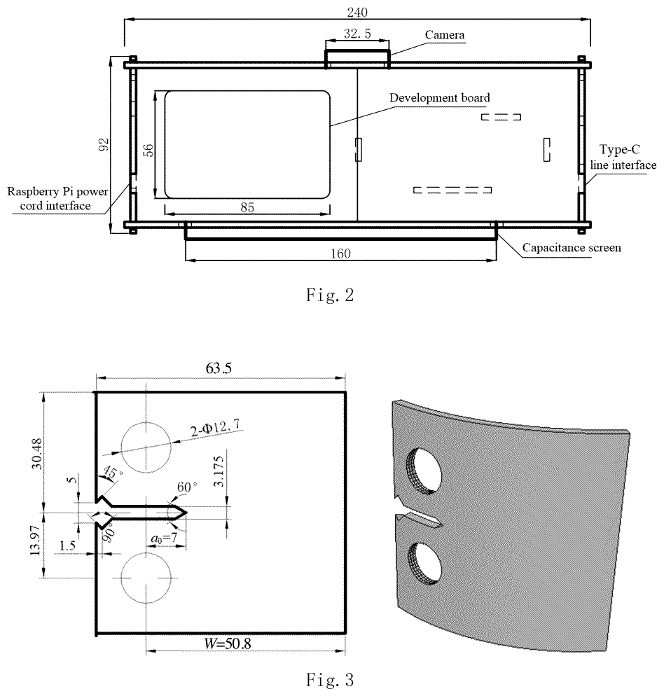

As shown in FIG. 2, in one embodiment, the fatigue crack propagation rate test device consists of a Raspberry Pi 4B development board, a HQ Camera with a 35 mm long-focus lens, a 7-inch capacitive screen, an integral device housing, a Raspberry Pi power cord, and a Type-C cord. The development board is placed inside the shell, a HQ Camera is installed at the front of the shell, a long-focus lens is installed for assistance on the camera to facilitate the adjustment device to be placed at different distances from the test-piece to perform focusing shooting, a 7-inch touch capacitance screen is installed at the rear of the shell to facilitate the touch operation and view the crack test results, a Raspberry Pi power core interface and a Type-C line interface are respectively provided at the left and right sides of the shell, and the device can be started after being connected to a power supply, and the device can be set to be connected to a wired or wireless network and to be connected to a cloud server to perform calculation and improve the calculation speed. The device takes a photograph or records a video of the crack test-piece through a camera, calculates on a local or cloud server, and finally displays the result of the crack length measurement on the screen.

Meanwhile, the present invention also provides a fatigue crack propagation rate test method based on deep learning, which includes the steps of:
step 1: acquiring photographs of test-pieces for training, and constructing a dual scale crack test-piece data set crack test-piece data set;
step 2: training the dual scale identification module through the dual scale crack test-piece data set;
step 3: acquiring a picture of a test-piece to be tested in real time, and determining whether there is a crack and a length of the crack through a trained dual scale identification module; and
step 4: obtaining the relationship that the crack propagation rate changes with the crack length through the fatigue crack length at different times of load cycle.

In step 1, the position of the test-piece in the tension-torsion combined fatigue test system is acquired by the acquisition unit, and the test-piece is photographed at each stage in the experiment, and after removing the blurred image in the photographed image which cannot identify the crack and the inactive image such as no crack, a total of 4479 active original images are obtained, and the size of each original image is 6000×4000 to establish a crack data set. 4479 original images are taken as global scale data set, 50% of the images are randomly selected from the data set as a training set, 33.3% of images are taken as a verification set, leaving 16.7% of images as a test set. In the global scale data set, there are 2240 pictures in the training set, 1493 in the verification set and 746 in the test set. In the training set and the verification set, the images with short cracks are locally clipped to obtain 1000×800, 650×170 images as local scale data sets. There are a total of 1181 local scale images in the local scale data set, of which a training set of 708 images and a verification set of 473images are randomly selected. The original image of global scale contains the information of the test-piece and the environment during the experiment, and the local scale image obtained after clipping removes the environment information such as the clamp except the crack, but only contains the crack information located in the middle of the image. The equipment used in the experiment is a tension-torsion combined fatigue test system (MTS). The test-piece is fixed on the MTS for fatigue cyclic loading. In the test process, a single lens reflex is used for image data acquisition in the model training stage. In the test stage, the trained network is integrated into the Raspberry Pi equipment terminal to identify and measure the crack in real-time to form a crack length measuring device, and it is preferable that the test-piece fills the entire screen of the crack image.

In step 2, specifically, a picture with a size of 6000×4000 in the global scale data set is taken as an example, a dual scale network structure is described; the global scale model uses a ResNet-50 network as a basic CNN to implement a feature extraction network, and extracts a feature map with a size of 57×38×1024, and the feature map is further provided as an input to a RPN to obtain a suggestion box of a region where a crack may be located. Fast CNN acquires feature maps from the basic CNN and the suggestion box from RPN. A feature surrounded by the suggestion box is referred to as generating a region of interests (RoIs). These RoIs are further input to a RoI pooling layer, and a maximum pooling operation is applied to extract a 14×14×1024 fixed-size feature vector from each RoI. These vectors are fed into the full-connection layer, objects in the image are classified by a Softmax classification layer, and the center coordinates, height and width of the crack bounding box are determined by the regression layer. Considering that the crack propagation test is usually a straight crack, in order to improve efficiency, the crack length is directly taken as the width of the detection box.

The training method of the local scale model is the same as that of the global scale model. The local scale data set is input into the local scale model to continue detection. The center coordinates of the crack bounding box, as well as their heights and widths are determined through the basic CNN network, the RPN network, the RoI pooling layer and the full-connection layer, respectively.

In step 3, the following steps are further included:
step 31: photographing by means of a camera in the crack propagation experiment to acquire a data set;
step 32: inputting the global picture of the data set into a global scale model to determine whether the test-piece ot be tested has a crack, and if it is a long crack global scale model, calculating the crack length; and

In the prediction process, the acquired global picture of the tested member is input into the global scale model, and the preliminary detection result is output. If the crack length is greater than 6 mm, it is determined as a long crack, the measurement ends, and the identified crack length and position are output.
step 33: if it is a short crack, generating a local image of the crack and inputting the same into the local scale model, and calculating the crack length.

If the crack length is less than 6 mm, it is determined as a small crack, and the crack box identified by the global scale model is clipped; on the basis of the detection box predicted by the global scale model, the length and width of the detection box are expanded by 100 pixels, and the expanded detection box will form a new local view box, and the original image is clipped on this basis to form a new local image. Then, the local images after clipping are input to the local scale model to measure the short crack length, to realize the accurate prediction of different length cracks under the whole times of cycle.

In step 4, the fatigue crack length a under different times of load cycle is acquired through the above-mentioned dual scale Faster R-CNN, and can further obtain the relationship between the fatigue crack propagation rate and the crack length, i.e., a curvilinear relationship of da/dN ˜a. In the existing fatigue crack propagation test methods, the crack propagation rate function is usually constructed for standard crack propagation test-pieces. Below, a method of constructing both standard and non-standard crack propagation rate function is given. According to the Paris rate equation, the function of fatigue crack propagation rate and stress intensity factor can be expressed as follows:

$$da / dN = {C ( Δ K )}^{m} \qquad ( 1 )$$

where, C and m represent crack propagation constants and ΔK represents a variation amplitude of the stress intensity factor. Under a constant amplitude load F, the relationship that the stress intensity factor changes with the crack propagation length a can be expressed as follows:

$$K = ( F / {BW}^{1 / 2} ) \times f ( a / W ) \qquad ( 2 )$$

$$where :$$

$$( 3 )$$

$$f ( a / W ) = ( 2 + a / W ) \times \frac{{k}_{0} + {k}_{1} ( a / W ) + {{k}_{2} ( a / W )}^{2} + {{k}_{3} ( a / W )}^{3} + {{k}_{4} ( a / W )}^{4}}{{( 1 - a / W )}^{3 / 2}}$$

where F represents a loading force, B represents a thickness of the test-piece, W represents a gauge length of the test-piece, a represents crack length, f represents a shape factor related to the geometric size of the test-piece, k₀, k₁, k₂, k₃ and k₄ represent the coefficient to be determined. For non-standard samples, the undetermined coefficients shall be fitted in combination with three-dimensional fracture mechanics. The relationship between the stress intensity factor (K) and the crack propagation length (a) is calculated by three-dimensional crack propagation simulation, and undetermined coefficients k₀, k₁, k₂, k₃ and k₄ can be obtained by fitting, combined with equations (2) and (3). Equations (2) and (3) can be bring into equation (1), combined with da/dN ˜a curvilinear relationship, the fatigue crack propagation rate constant C and m can be obtained by fitting.

The proposed method can be used to measure the crack propagation rate of non-standard samples with arbitrary geometric size. Especially, the proposed dual scale Faster R-CNN method can automatically identify and accurately measure the crack length under the whole times of load cycle, which makes up for the shortcomings of the existing visual method and flexibility method, and enriches the test system of crack propagation rate.

As shown in FIG. 3, in one embodiment, the transmission shaft is a tube axis member formed by an extrusion strengthening process, the wall of the tube is a curved surface. Because it is thin, it is difficult to be processed to conform to a plane test-piece that meets the requirements of existing standard test methods for fatigue crack propagation rates. If the curved surface test-piece is rolled into a plane test-piece, it will cause residual stress, material hardening, etc., resulting in that the rolled test-piece is difficult to reflect the true fatigue characteristics of the original test-piece. The present invention will provide an idea of a non-standard crack propagation test-piece design based on a standard CT compact tensile test-piece. In order to adapt to the clamp and measuring range of an MTS fatigue testing machine, a dimension design of the non-standard crack propagation test-piece is still referred to a standard CT compact tensile test-piece. The test-piece has a length of W=63.5 mm a crack notch a₀=7 mm and a thickness of 1.8 mm. The total crack length of the test-piece is the sum of the crack notch length and the macroscopic surface crack length. The dimensions of the external surface of the cut test-piece is consistent with that of the standard CT test-piece, and the cutting direction of the hole and notch is along the radial direction of the tube axis.

For other non-standard test-pieces, it is recommended to keep the two-dimensional projection of the test-piece consistent with the dimension of the standard CT test-piece, with the cutting direction perpendicular to the two-dimensional projection.

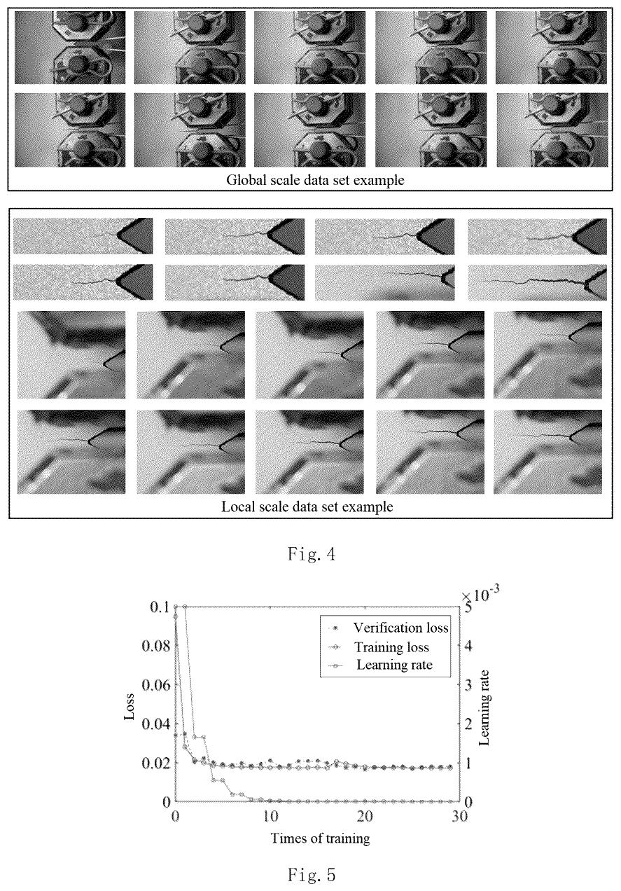

As shown in FIG. 4, the data set is acquired by photographing with a common camera in the crack propagation experiment for acquiring a data set. According to the present invention, the images of different periods of crack propagation of a tube axis test-piece acquired from five crack propagation experiments are used as a crack data set, and it is preferable that the test-piece fills the whole picture in the data set. A total of 4479 active crack images are acquired during the experiment, in which short cracks are determined when the crack length a in the image is less than 6 mm. Table 1shows the number and size of images in each data set. The global scale crack data set consists of all active crack images and is divided into a training set of 2240 images, a verification set of 1493images and a test set of 746 images. The local scale crack data set is obtained by locally taking the short crack images in the global scale training set and the verification set, and only the image of the cracks retained during the taking. In order to enhance the data of local scale crack set, two different sizes of parts are locally taken from the original image. Therefore, there are two kinds of pictures with two different sizes of 1000×800 and 650×170 in the local crack data set, respectively. There are 1181 locally taken local scale pictures and corresponding labels in the data set, including a training set of 708 images and a verification set of 473 images. Therefore, there are 4479+1181=5660 pictures in the dual scale data set, of which there are a training set of 2948 images, a verification set of 1966 images and a test set of 746 images. These data sets will be used to train, verify and test the proposed dual scale crack test-piece data set Faster R-CNN model.

TABLE 1
Number and size of pictures in each data set

| | Training stage | | | | Test stage | |
|---|---|---|---|---|---|---|
| | Training set | | Verification set | | Test set | |
| | Number | Size | Number | Size | Number | Size |
| Global | 2240 | 6000 × 4000 | 1493 | 6000 × 4000 | 746 | 6000 × 4000 |
| scale data | | | | | | |
| set | | | | | | |
| Local scale | 708 | 1000 × 800, | 473 | 1000 × 800, | — | — |
| data set | | 650 × 170 | | 650 × 170 | | |
| Dual scale | 2948 | 6000 × 4000, | 1966 | 6000 × 4000, | 746 | 6000 × 4000 |
| data set | | 1000 × 800, | | 1000 × 800, | | |
| | | 650 × 170 | | 650 × 170 | | |

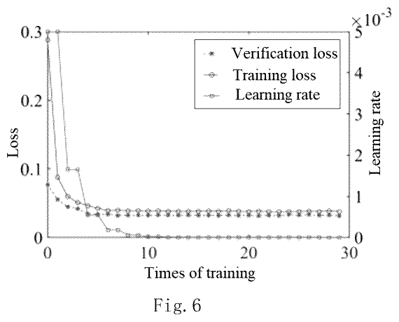

As shown in FIGS. 5 and 6, the above-mentioned global scale and local scale data sets are trained based on the Faster R-CNN algorithm to obtain a global scale model 1 and a local scale model 2. During the training process, the global scale data set and the local scale data set will be trained by the Faster R-CNN, respectively. The total training times is 30, and a gradient descent method is used for optimization. It can be seen from FIGS. 5 and 6 of the verification loss graph that the loss function tends to converge for both the local scale and the global scale after the fifth training, thus setting the total training times as five times.

The trained model is tested by a test set, and the length and position of the crack in the image can be obtained by inputting the test image in the dual scale crack test-piece data set Faster R-CNN model. The test images used in the prediction process are different from the pictures in the training set and the verification set described above. In addition, the length obtained by the test is the pixel length occupied by the crack in the image; if it is necessary to obtain the true crack length, it is also necessary to convert the pixel crack length into the true crack length according to the scale of the tested picture. In this model test experiment, the length of 1 mm corresponds to 68-pixel points in the tested picture.

In the prediction process, firstly, a new picture to be measured is input into a global scale model, and a preliminary detection result is output; if the crack length is greater than 6 mm, it is determined as a long crack, the measurement ends, and the identified crack length and position are output; if the crack length is less than 6 mm, it is determined as a short crack, clipping is performed based on the crack box identified by the global scale model, the clipped picture is input into the local scale model for identification again, and the identified short crack length and position are output.

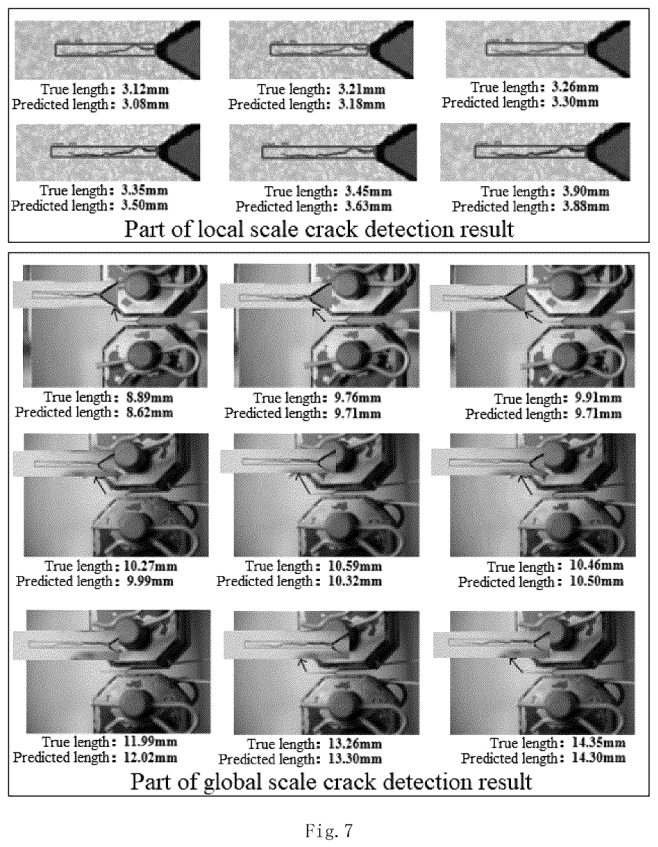

As shown in FIG. 7, when a new picture of cracks is input into the dual scale crack test-piece data set crack detection model, the crack can be detected from the image and the true crack length can be given. It can be seen from the figure that the results predicted by the method of the present invention are in good agreement with the real results regardless of short or long cracks.

Finally, a total of 746 pictures in the test set are predicted by the proposed dual scale crack test-piece data set Faster R-CNN, and the accuracy of crack length is 98.79% while an error range is set as 5% and the accuracy of crack length is 91.82% while an error range is set as 3%. There are 197 short crack images in the test set, which are measured by the global single scale Faster R-CNN model and the dual scale Faster R-CNN model. As shown in Table 2, when the global single scale model is used for identification and measurement, the accuracy of the crack length is 81.72% while an error range is set as 5% and the accuracy of the crack length is 22.84% while an error range is set as 3%. When the dual scale crack test-piece data set model is used for identification and measurement, the accuracy of the crack length is 96.44% while an error range is set as 5% and the accuracy of the crack length is 86.29% while an error range is set as 3%. The results show that the prediction accuracy and precision of short crack length are significantly improved by the proposed dual scale crack test-piece data set Faster R-CNN model. Therefore, the dual scale crack test-piece data set Faster R-CNN model can not only identify the long cracks on the global scale, but also accurately detect the short cracks on the local scale.

TABLE 2
Short Crack Length Prediction Error Analysis

| | Picture scale with an | Picture scale with an |
|---|---|---|
| Method | error less than 5% | error less than 3% |
| Conventional Faster R-CNN | 81.72% | 22.84% |
| Proposed dual scale Faster | 96.44% | 86.29% |
| R-CNN | | |

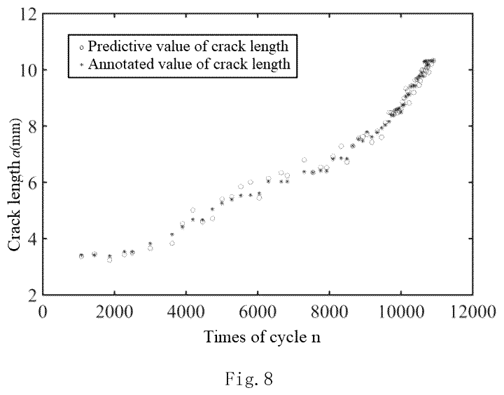

Moreover, a crack length measuring device is developed to measure the fatigue crack length of another new test-piece by integrating the above-mentioned deep learning model into a Raspberry Pi computer integrated microprocessor terminal. During the experiment, the device can detect the crack in real time, and the position of the crack is given by a rectangular box. The dual scale Faster R-CNN crack detection model is used to detect and measure the crack images under different times of cycles in the crack propagation experiment for tube axis test-pieces. The recorded crack length results are as shown in FIG. 8, where the blue dots represent the labeled crack data and the red dots represent the predicted crack data. It can be seen from the figure that the error between the predictive value and the annotated value of the crack length is small, which verifies the measurement accuracy and generalization of the dual scale Faster R-CNN model of the present invention. Since in the crack propagation experiment, it cannot be guaranteed that the image photographed at each time is just the image with the maximum crack opening at this time of cycle, when recording the length, it is recommended to record the longest crack length value identified multiple times in a short time.

The rule that the equivalent stress intensity factor of the transmission shaft test-piece changed along with the crack propagation length through three-dimensional fatigue crack propagation analysis. The relationship between the stress intensity factor and the crack length is put into equation (3), and the unknown parameter k₀=1.20, k₁=−0.7129, k₂=0.9463, k₃=−5.184, and k₄=4.9 can be obtained by regression fitting. According to the relationship between the crack length and the times of load cycle predicted by the above-mentioned test and Paris fatigue crack propagation rate model, the fatigue crack propagation rate constant of the tail transmission shaft can be obtained as C=1.5977e−10 and m=4.4505. It can be seen therefrom that the method proposed in the present invention can not only realize automatic prediction of the crack propagation rate, but also be adapted to the fatigue crack propagation rate test of a non-standard crack propagation test-piece.

The present invention is not limited to the embodiments described above, but can be implemented in various other embodiments by those skilled in the art according to the embodiments and the disclosure of the drawings. Therefore, it is intended that the present invention cover the modifications and variations of this invention provided they come within the scope of the appended claims and their equivalents.

1. A fatigue crack propagation rate test device based on deep learning, wherein the fatigue crack propagation rate test device comprises an acquisition unit, a processing unit and a display unit;
the acquisition unit is configured to acquire a picture of a test-piece;
the display unit is configured to show a crack detection result, display a position of crack in picture of cracked test-piece and output the detected crack length;
the processing unit is configured to load a dual scale cracked test-piece data set, a dual scale identification module and a module for fitting a relationship between a fatigue crack propagation rate and a stress intensity factor;
the dual scale cracked test-piece data set comprises a global scale data set and a local scale data set, wherein the global scale data set stores panoramic images in test-piece crack propagation experiments, and the local scale data set stores images only containing crack information in the test-piece crack propagation experiments;
the dual scale identification module comprises a global scale identification module and a local scale identification module; the global scale identification module is trained by the global scale data set for identifying the location and length of long cracks or a preliminary detection result of short cracks; the local scale identification module is trained by the local scale data set for identifying the location and length of the short cracks; and
the module for fitting a relationship between a fatigue crack propagation rate and a stress intensity factor is used for obtaining the stress intensity factor of any crack test-piece on the crack propagation path and constructing a function of the crack propagation rate and the stress intensity factor;
both the global scale model and the local scale model adopt a Faster-RCNN network, while the Faster-RCNN network comprises a basic CNN network, a RPN network and a Fast-RCNN network;
the basic CNN network performs feature map extraction on the data set and is respectively connected to the RPN network and the Fast-RCNN network;
in the process of training the RPN network, the RPN network is connected to the dual scale cracked test-piece data set at the same time to acquire annotation information to generate a suggestion box;
the Fast-RCNN network comprises a RoI pooling layer and a full-connection layer, which are respectively connected to a basic CNN network and a RPN network; based on a feature map of the basic CNN network and a suggestion box of the RPN network, the features surrounded by the suggestion box are referred to as region of interests; the region is further input to the RoI pooling layer to extract a feature vector of a pre-set size; the feature vector is fed into the full-connection layer, objects in the image are classified by the full-connection layer, and the center coordinates, height and width of the crack bounding box are determined.

2. The fatigue crack propagation rate test device of claim 1, wherein the dual scale identification module calculates a crack length from a preset pixel-to-real size relationship based on a crack pixel size in output image.

3. The fatigue crack propagation rate test device of claim 1, wherein the function of the fatigue crack propagation rate and the stress intensity factor of the module for fitting a relationship between a fatigue crack propagation rate and a stress intensity factor is expressed as follows:
$$da / dN = {C ( Δ K )}^{m}$$
wherein, C and m are crack propagation constants and ΔK is a variation amplitude of the stress intensity factor;
under a constant amplitude load F, the relationship that the stress intensity factor changes with the crack propagation length a can be expressed as follows:
$$K = ( F / {BW}^{1 / 2} ) \times f ( a / W )$$
$$wherein :$$
$$f ( a / W ) = ( 2 + a / W ) \times \frac{{k}_{0} + {k}_{1} ( a / W ) + {{k}_{2} ( a / W )}^{2} + {{k}_{3} ( a / W )}^{3} + {{k}_{4} ( a / W )}^{4}}{{( 1 - a / W )}^{3 / 2}}$$
wherein F represents a loading force, B represents a thickness of the test-piece, W represents a gauge length of the test-piece, a represents crack length, f represents a shape factor related to the geometric size of the test-piece, k₀, k₁, k₂, k₃ and k₄ represent the coefficient to be determined.

4. A fatigue crack propagation rate test method based on the fatigue crack propagation rate test device of claim 1, wherein the fatigue crack propagation rate test method comprises the following steps:
step 1: acquiring photographs of test-pieces for training, and constructing a dual scale cracked test-piece data set;
step 2: training the dual scale identification module through the dual scale cracked test-piece data set;
step 3: acquiring a picture of a to-be-tested component in real time, and determining whether there is a crack and a crack length through a trained dual scale identification module; and
step 4: obtaining the relationship that the crack propagation rate changes with the crack length through the fatigue crack length at different times of load cycle.

5. The fatigue crack propagation rate test method of claim 4, wherein step 3 includes the steps of:
step 31: photographing by means of a camera in the crack propagation experiment to acquire a data set;
step 32: inputting the global pictures in the data set into a global scale model to determine whether the tested member has a crack, and if it is a long crack, the global scale model calculates the crack length; and
step 33: if it is a short crack, generating a local image of the crack and inputting the same into the local scale model, and calculating the crack length.

6. The fatigue crack propagation rate test method of claim 5, wherein in step 32, if the crack length is greater than 6 mm, the crack length is determined as a long crack, otherwise, the crack length is determined as a short crack.
